(19) United States
(12) Patent Application Publication
(10) Pub. No.: US 2011/0113354 A1
(43) Pub. Date: May 12, 2011

(54) ALWAYS-ON-TOP MEDIA PLAYER LAUNCHED FROM A WEB BROWSER

(75) Inventors: Venkatesan Thiyagarajan, Sale (IN); TVN Kishore Babu, Bangalore (IN)

(73) Assignee: SLING MEDIA PVT LTD, Bangalore (IN)

(21) Appl. No.: 12/617,271

(22) Filed: Nov. 12, 2009

(51) Int. Cl. G06F 15/16; H04N 5/91; G06F 3/01

(52) U.S. Cl. 715/760; 709/231

(57) ABSTRACT

A method for presenting digital media content is provided. The method directs the displaying of a web page on a display, where the web page includes a media player. The method detects certain activity associated with the media player and, in response to the detected activity, renders a stand-alone always-on-top media player on the display. The stand-alone media player is used for presentation of media content such as streaming media. The stand-alone media player is launched with default always-on-top display characteristics such that it remains visible even if another open application has focus.

### TECHNICAL FIELD

Embodiments of the subject matter described herein relate generally to the presentation of digital media content at a presentation device. More particularly, embodiments of the subject matter relate to an always-on-top media player that is launched from a web page.

### BACKGROUND

Streaming media techniques can be used to provide content, including audio content and video content, to users of various media presentation devices, such as personal computers, handheld mobile devices, laptop computers, or the like. For example, Sling Media, Inc. provides an online streaming media service that allows users to view video content at their convenience and on demand. Other websites provide hosting services that allow users to upload video clips for purposes of sharing or archiving. Traditionally, web-based streaming media sites provide fixed, embedded, or docked media player components that are rendered and displayed as an integral part of a web page. Some web-based streaming media sites provide stand-alone or undocked media player components that can be launched as browser windows from their respective host web pages. In this regard, an undocked media player is displayed in one distinct and separate browser window, while the originating host web page is displayed in another distinct and separate browser window.

In accordance with conventional techniques, undocked media player windows are generated with no display priority or preference relative to other application windows that might be concurrently open on the media presentation device. In this regard, an undocked media player window will appear “on top” of other windows when the undocked media player window has focus, otherwise, the undocked media player window could be partially or completely obscured, blocked, or overlapped by one or more other application windows. Consequently, the user's view of a conventional undocked media player window can become partially or totally obscured during concurrent use or manipulation of other open applications.

### BRIEF SUMMARY

A method is provided for managing the presentation of streaming media. The method directs the displaying of a web page comprising a media player on a display element, and detects activity associated with the media player. In response to the detected activity, the method renders, on the display element, a stand-alone always-on-top media player for presentation of streaming media.

Also provided is a web browser application stored on tangible media of a computing device having a display element associated therewith. The web browser application includes processor-executable instructions that, when executed by the computing device, cause the computing device to perform a method that involves: providing an embedded media player within a web page displayed on the display element; displaying a window for a stand-alone media player on the display element, the window being outside of, distinct from, and separate from the web page, the window by default having always-on-top display characteristics; and presenting streaming media with the stand-alone media player.

Also provided is a method of presenting digital media content using a media presentation device configured to execute a web browser application. This method begins by rendering, on a display element of the media presentation device, a docked media player and a graphical control element that represents an undock media player command. Rendering the docked media player and the graphical control element is controlled by the web browser application. The method also detects selection of the graphical control element and, in response to the detected selection of the graphical control element, launches a stand-alone media player on the display element. The stand-alone media player is undocked from, different than, and independent of the docked media player, and the stand-alone media player has default always-on-top display characteristics. The launching of the stand-alone media player is controlled by the web browser application, and the method proceeds by presenting, with the stand-alone media player, content associated with a digital media file.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a media presentation system;

FIG. 2 is a schematic representation of an exemplary embodiment of a media presentation or computing device that is configured to support the presentation of digital media content;

FIG. 3 is a diagram that illustrates an exemplary web browser window having a media player component associated therewith;

FIG. 4 is a diagram that illustrates an exemplary web browser window and an overlying stand-alone media player window;

FIG. 5 is a diagram that illustrates application windows rendered on a display element, along with an always-on-top stand-alone media player window; and

FIG. 6 is a flow chart that illustrates an exemplary embodiment of a media presentation process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or processor-executed. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

According to various embodiments, a separate media player window can be launched from a web page (which may be an online media portal, a web-based content provider, etc.). The launched media player window is separate, distinct, and independent from the web page window from which it originated. In certain embodiments, the launched media player window has “always-on-top” display characteristics by default or by user configuration. In this regard, the media player window remains on top of other application windows on the display element, regardless of which application window has current focus. This always-on-top feature enables the user to view the content presented in the media player window while manipulating or otherwise working with other open application windows.

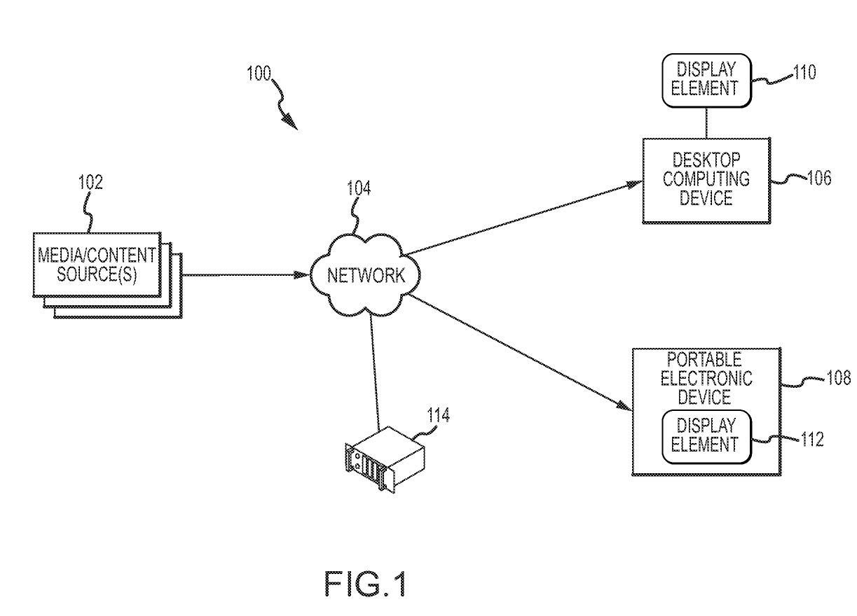

Turning now to the figures and with initial reference to FIG. 1, an exemplary embodiment of a media presentation system 100 can be utilized to provide digital media content to one or more media presentation devices. This particular embodiment of the system 100 includes one or more media/content sources 102 that provide digital media content (in, for example, a streaming format) to remotely-located media presentation devices over a network 104. For purposes of this description, a “media presentation device” can be one or more computing devices, one or more components, a system, an appliance, or the like, which is suitably configured to receive, process, render, and/or play digital media content for one or more users. Thus, the system 100 may cooperate with any number of media presentation or computing devices, including, without limitation: a desktop computer; a portable computer; a handheld computer; a mobile telephone; a personal digital assistant; a video game console, a mobile video game device; a media server; a mobile media player device; a web-enabled audio/visual component; a medical device; a web-enabled household appliance; a set-top box; a television component; etc.

In many embodiments, a media presentation device is a general purpose computing device that includes a media player application in software or firmware that is capable of receiving and presenting media content to the user of the device as appropriate. Although any number and different types of presentation devices could be deployed in a practical embodiment, FIG. 1 depicts one media presentation device 106 configured as a desktop computing device and another media presentation device 108 configured as a portable electronic device. The desktop media presentation device 106 cooperates with an attached display element 110, while the portable media presentation device 108 includes an integrated or internal display element 112. For purposes of this description, a media presentation device may be a component having a physically distinct display element coupled thereto (such as the combination of the desktop media presentation device 106 and its display element 110) or a component having an integrated or physically indistinct display element (such as the portable media presentation device 108 and its display element 112).

A media presentation device 106/108 in the system 100 can present audio and/or visual content to a viewer on its respective display element, using a suitable media player application or window. Although not depicted in FIG. 1, a media presentation device 106/108 may include or cooperate with at least one speaker, audio transducer, or other sound-generating element that supports the presentation of the audio portion of media streams. In various embodiments, a server 114 may also be provided to communicate with the media/content sources 102 and/or the media presentation devices 106/108 via the network 104 to assist these devices in locating each other, maintaining security, providing or receiving content or information, and/or to provide any other features as desired. The server 114 is not required in all embodiments, however, and the concepts described herein may be deployed in any data streaming application or media serving environment.

The network 104 is any digital or other communications network capable of transmitting messages between senders (e.g., the media/content sources 102) and receivers (e.g., the media presentation devices 106/108). In various embodiments, the network 104 includes any number of public or private data connections, links or networks supporting any number of communications protocols. The network 104 may include the Internet, for example, or any other network based upon TCP/IP or other conventional protocols. In various embodiments, the network 104 also incorporates a wireless and/or wired telephone network, such as a cellular communications network for communicating with mobile phones, personal digital assistants, and/or the like. The network 104 may also incorporate any sort of wireless or wired local area networks, such as one or more IEEE 802.3 and/or IEEE 802.11 networks.

The media/content sources 102 and/or the media presentation devices 106/108 are therefore able to communicate in any manner with the network 104. Such communication may take place over a wide area link that includes the Internet and/or a telephone network, for example; in other embodiments, communications between the media/content sources 102 and the media presentation devices 106/108 may take place over one or more wired or wireless local area links that are conceptually incorporated within the network 104. In various equivalent embodiments, the media/content sources 102 and the media presentation devices 106/108 may be directly connected via any sort of cable (e.g., an Ethernet cable or the like) with little or no other network functionality provided.

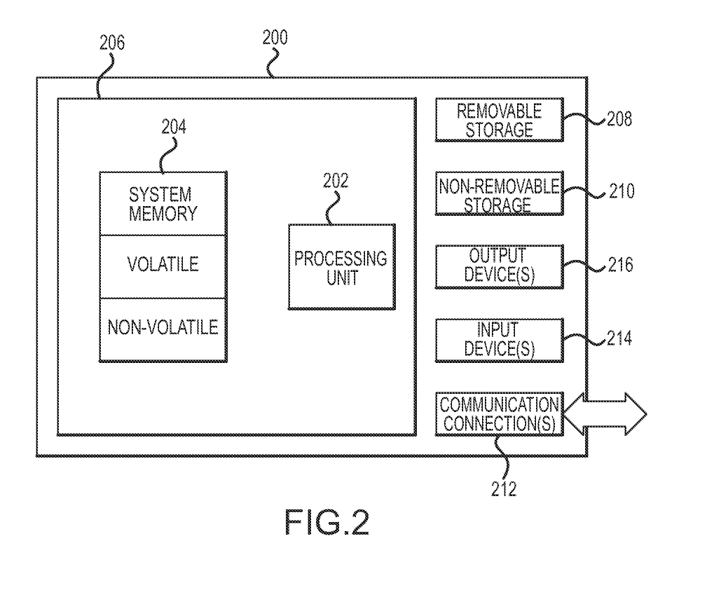

As mentioned above, certain embodiments of the system 100 utilize media presentation devices that are based upon computing device platforms. In this regard, FIG. 2 is a schematic representation of an exemplary embodiment of a media presentation or computing device 200 that is configured to support the presentation of digital media content. The illustrated computing device 200 is only one example of a suitable implementation, and it is not intended to suggest any limitation as to the scope of use or functionality of any practical embodiment. The computing device 200 and certain aspects of the exemplary embodiments may be described in the general context of computer-executable instructions, such as program modules, application code, or software executed by one or more computers or other devices. Generally, program modules include routines, programs, objects, components, data structures, and/or other elements that perform particular tasks or implement particular abstract data types. Typically, the functionality of the program modules may be combined or distributed as desired in various embodiments.

The computing device 200 typically includes at least some form of tangible computer-readable or processor-readable media. In this regard, processor-readable media can be any available media that can be accessed by the computing device 200 and/or by applications executed by the computing device 200. By way of example, and not limitation, processor-readable media may comprise tangible computer storage media, which may be volatile, nonvolatile, removable, or non-removable media implemented in any method or technology for storage of information such as processor-executable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 200.

Referring again to FIG. 2, in its most basic configuration, the computing device 200 typically includes at least one processing unit 202 and a suitable amount of memory 204. This basic configuration is identified in FIG. 2 by reference number 206. The processing unit 202 is preferably configured to execute and carry out processor-executable instructions associated with the media presentation techniques, operations, and methods described herein. Accordingly, processor-readable media used by the computing device 200 is accessible by the processing unit 202, and the processor-readable media stores the appropriate processor-executable instructions needed to support the various media presentation and media player techniques.

Depending on the exact configuration and type of computing device 200, the memory 204 may be volatile (such as RAM), non-volatile (such as ROM, flash memory, etc.) or some combination of the two. Additionally, the computing device 200 may also have additional features/functionality. For example, the computing device 200 may also include additional storage (removable and/or non-removable) including, but not limited to, magnetic or optical disks or tape. Such additional storage is represented in FIG. 2 by the removable storage 208 and the non-removable storage 210. The memory 204, the removable storage 208, and the non-removable storage 210 are all examples of computer storage media as defined above. One or more memory devices or elements of the computing device 200 can be used to store data and information as necessary to support the various techniques and methodologies described here. For example, a memory element could be configured to store user settings or preferences related to how media is presented, the manner in which a stand-alone media player window is launched from a web browser, or the like.

The computing device 200 may also include or support communications connection(s) 212 that allow the computing device 200 to communicate with other devices, such as other networked computing devices, media or content sources, or the like. Depending upon the implementation, the communication connection(s) 212 may include, without limitation, suitably configured interfaces that allow the computing device 200 to communicate with a network such as the Internet, external databases, external memory devices, and the like.

The computing device 200 may also include or communicate with certain input device(s) 214 such as a keyboard, mouse or other pointing device, pen, voice input device, touch input device, etc. The computing device 200 may also include or communicate with output device(s) 216 such as a display element, speakers, printer, or the like. For example, during operation of the computing device 200, a display element may be utilized for playback of digital media content using a media player application. All of these devices are well know in the art and need not be discussed at length here.

An exemplary embodiment of a media presentation device includes a web browser application stored on tangible processor-readable media. A web browser application includes functionality that enables it to retrieve, process, and present information (e.g., web pages, images, media, or other content) available on the Internet and/or on private networks. Web browsers usually identify resources using Uniform Resource Locators (URLs). Web browser applications are well known and, therefore, they will not be described in detail here. Exemplary web browser applications suitable for use with the systems and media player technology described here include, without limitation: the Internet Explorer browser application by Microsoft Corp.; the Firefox browser application by Mozilla; the Safari browser application by Apple, Inc.; and the Chrome browser application by Google.

An exemplary web browser application includes or cooperates with processor-executable instructions that, when executed by its host media presentation device, causes the media presentation device to carry out certain processes, techniques, and methodologies (which are described in more detail below). Of course, such a web browser application can also support conventional and routine web browser features and functionality if so desired. The web browser application and other processor-executable features of the systems described herein may leverage conventional computer science and programming techniques that are applicable to the particular operating system of the host media presentation device or computing device. In this regard, the web browser application may include, initiate, or otherwise cooperate with lightweight applets (e.g., applets written in the Java programming language, ActiveX controls, or the like, which may or may not be operating system specific), plugin modules that add functionality to the core web browser application, and the like. Moreover, the web browser application may be fully compatible with the application programming interface employed by the host operating system (e.g., the Windows operating system from Microsoft Corp.).

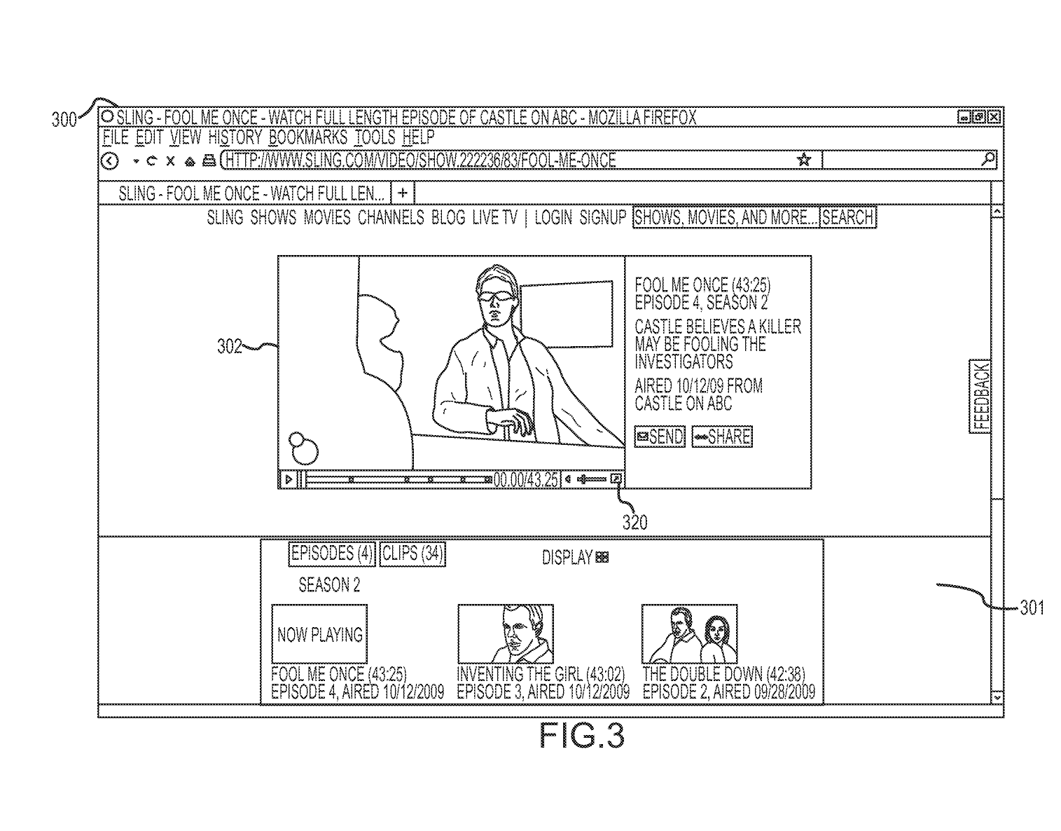

For example, FIG. 3 is a diagram that illustrates an exemplary web browser window 300. The web browser window 300 is used to present a web page 301 having a media player 302 associated therewith. In this view, the media player 302 is considered to be fixed, docked, or embedded in the web page 301 because it is rendered and displayed as an integral part of the web page 301. Thus, if the web browser window 300 is minimized, the media player 302 will be removed from the display element. Moreover, if the web browser window 300 is resized, the media player 302 might also be resized.

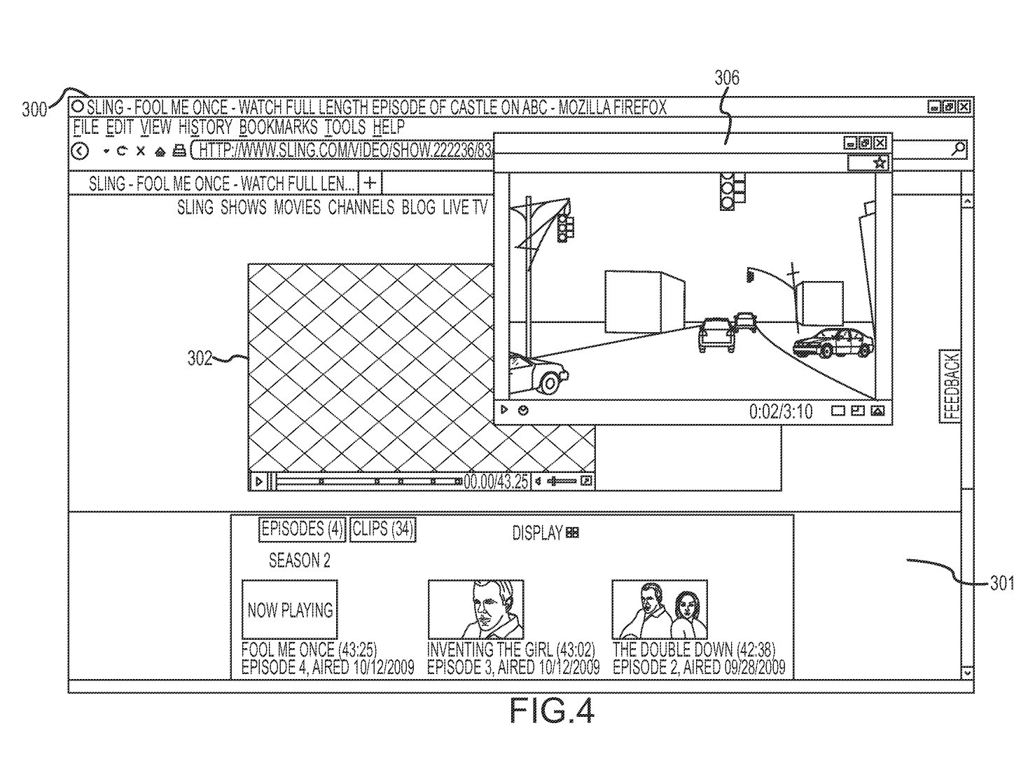

For the embodiments described here, a user can choose to launch a separate stand-alone media player from the web page 301 and/or from the docked media player 302. In this regard, FIG. 4 is a diagram that illustrates the web browser window 300 after activation of a stand-alone media player window 306. This stand-alone media player window 306 can be used to present media content in a manner that is divorced from both the docked media player 302 and the web browser window 300. As explained in more detail below, the stand-alone media player window 306 represents a distinct and separate window that can be manipulated, moved, minimized, maximized, resized, and otherwise managed independently of the web browser window 300. In certain implementations, the stand-alone media player window 306 could be realized as an HTML video element such that the host web browser application need not utilize any plugins to support this feature.

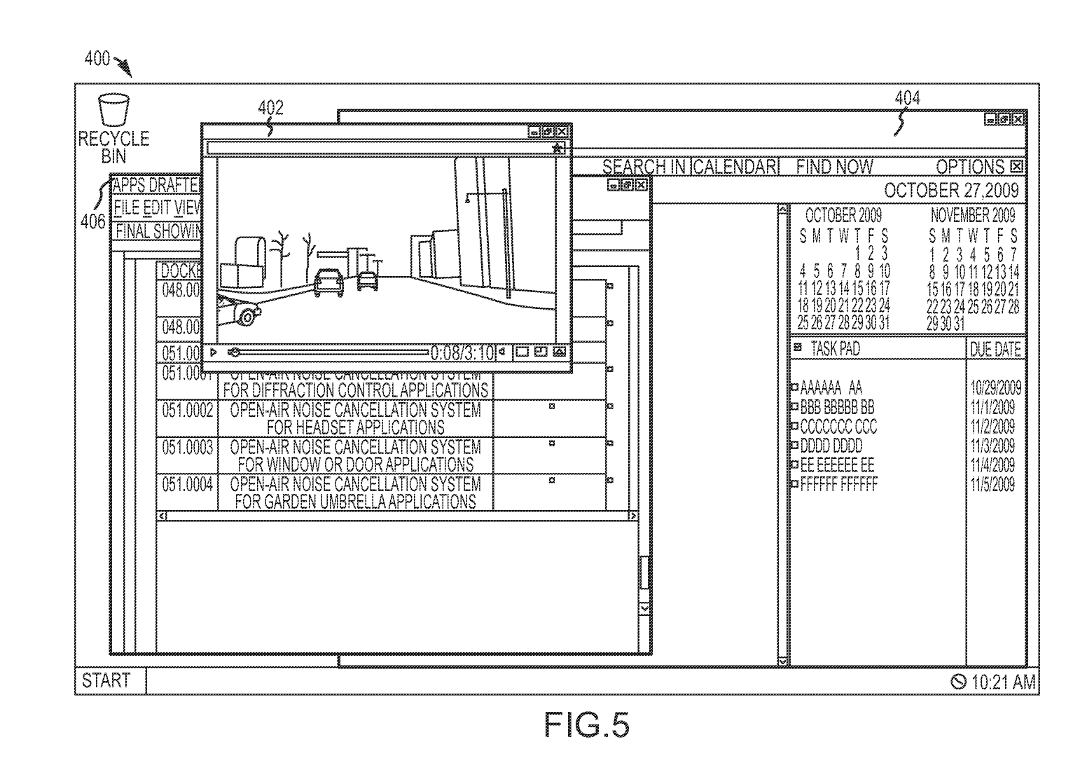

Notably, the stand-alone media player window 306 is deployed with default always-on-top display characteristics. In other words, when launched, the stand-alone media player window 306 will automatically be displayed in full, and without any other application windows overlapping any portion of it. Moreover, the default always-on-top display characteristics ensure that the stand-alone media player window 306 will be fully displayed regardless of how many other application windows are deployed, and regardless of manipulation, maximizing, resizing, or shifting of other application windows. Accordingly, if video content is being presented in the stand-alone media player window 306, the user can focus on and continue working with one or more “underlying” applications without inadvertently obscuring any portion of the stand-alone media player window 306. In this regard, FIG. 5 is a diagram that illustrates application windows rendered on a display element 400, along with an always-on-top stand-alone media player window 402. FIG. 5 depicts an exemplary scenario where a first application window 404 occupies most of the area of the display element 400, a second application window 406 overlies a portion of the first application window 404, and the stand-alone media player window 402 overlies a portion of the first application window 404 and a portion of the second application window 406. FIG. 5 clearly shows how the stand-alone media player window 402 is rendered and displayed on top of the other application windows 404/406.

The always-on-top display characteristics of the stand-alone media player window 402 prevent the stand-alone media player window 402 from being fully or partially obscured by the other application windows 404/406. Thus, even if one of the underlying application windows 404/406 gains focus (e.g., if the user decides to manipulate or interact with one of those application windows 404/406), the stand-alone media player window 402 will be displayed in its entirety. In certain embodiments, the stand-alone media player window 402 can be resized, repositioned on the display screen, or maximized while still preserving its always-on-top characteristics. The stand-alone media player window 402 could also be minimized if so desired, however, if thereafter restored or maximized, the stand-alone media player window 402 will automatically be displayed on top again.

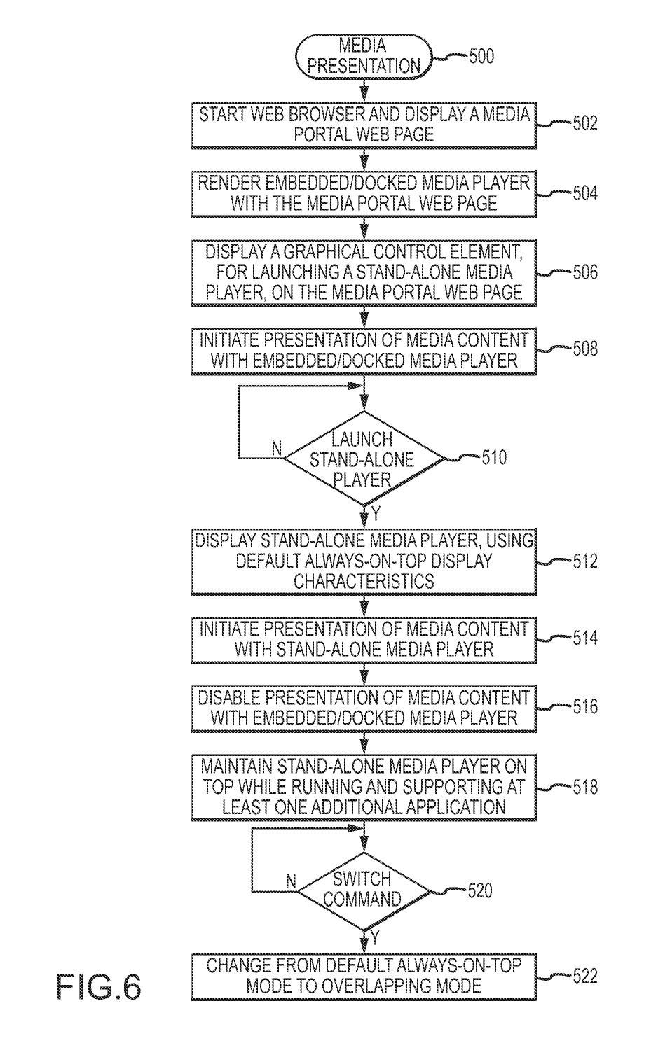

A media presentation or computing device can be configured to support the default always-on-top functionality of an undocked media player window (described above). In this regard, FIG. 6 is a flow chart that illustrates an exemplary embodiment of a media presentation process 500 that could be performed by a media presentation or computing device. The various tasks performed in connection with process 500 may be performed by software, hardware, firmware, or any combination thereof. For illustrative purposes, the following description of process 500 may refer to elements mentioned above in connection with FIGS. 1-5. In practice, portions of process 500 may be performed by different elements of the described system. More specifically, certain aspects of process 500 could be executed by one or more application programs, programming modules, drivers, applets, application programming interfaces, and/or other features or architectures resident at the host media presentation or computing device. It should be appreciated that process 500 may include any number of additional or alternative tasks, the tasks shown in FIG. 6 need not be performed in the illustrated order, and process 500 may be incorporated into a more comprehensive procedure or process having additional functionality not described in detail herein. Moreover, one or more of the illustrated tasks could be omitted in an embodiment of process 500 (assuming that the intended functionality is preserved).

The media presentation process 500 may begin by starting, initializing, or launching an appropriate web browser and accessing/displaying a suitable web page using the web browser (task 502). For this embodiment, task 502 is associated with the display of a web page that provides access to digital media files, e.g., a streaming media portal web page. In this regard, the process 500 will direct the displaying (on a display element of the host media presentation or computing device) of a web page that includes a media player element or component. For this exemplary embodiment, the process 500 renders a fixed, embedded, or docked media player in (or otherwise with) the media portal web page (task 504). In conjunction with the display of the web page, one or more graphical control elements associated with the docked media player could be displayed or otherwise provided. For example, a graphical control element corresponding to a “launch media player” command or an “undock media player” command may be displayed on the web page and/or with the docked media player (task 506).

In certain implementations, displaying the web page, the docked media player, and the associated graphical control element(s) is controlled or managed by the web browser application running at the media presentation or computing device. Referring again to FIG. 3, the exemplary web browser window 300 provides the docked media player 302 within the web page 301, i.e., the media player 302 is considered to be an integral component of the web page 301 itself. FIG. 3 also depicts an exemplary graphical control element 320 that represents a user-selectable button that, when activated or selected, initiates the launching of a stand-alone always-on-top media player window (e.g., the stand-alone media player window 306 shown in FIG. 4). FIG. 3 illustrates how the process might direct the displaying of the web page 301 in a first distinct and defined window (e.g., the web browser window 300) on the display element of the media presentation or computing device.

Referring back to FIG. 6, the docked media player may (but need not) be used to initiate the presentation of media content (task 508). In this regard, the docked media player could initially present content associated with a digital media file (e.g., streaming media) in the media player of the web page by default. Alternatively, playback of media in the media player of the web page may be initiated by the user. In certain scenarios, beginning playback of the media content may be delayed until after the stand-alone always-on-top media player has been deployed. In practice, the stand-alone media player could be activated in any suitable manner. For example, the process 500 could detect certain activity associated with the docked media player, detect certain interaction with the web page, detect certain interaction with the docked media player, or the like. In certain embodiments, such as the illustrated embodiment, launching of the stand-alone media player is performed when the media presentation or computing device detects the selection of the graphical control element 320 (see FIG. 3).

If the process 500 detects a command, instruction, parameter, or other applicable state (query task 510), then it will proceed by launching and rendering the stand-alone media player on the display element (task 512). Accordingly, the stand-alone media player is rendered and displayed in response to the detected activity (e.g., interaction with the docked media player and/or interaction with the web page that includes the docked media player). In certain embodiments, the launching and display of the stand-alone media player is controlled and/or managed by the web browser application. Notably, the stand-alone media player is initially launched such that it has, by default, certain always-on-top characteristics.

FIG. 4 illustrates how the stand-alone media player window 306 is generated, rendered, and displayed in a second distinct and defined window on the display element of the media presentation or computing device, where this second window is separate from the web browser window 300. Indeed, the stand-alone media player window 306 may be outside of, distinct from, separate from, undocked from, different than, and/or independent of the web page from which it was spawned. Likewise, the stand-alone media player window 306 may be outside of, distinct from, separate from, undocked from, different than, and/or independent of the docked media player contained in the originating web page. In certain implementations, the stand-alone media player window 306 is a non-browser window. In other words, the stand-alone media player window 306 is not launched as a new instantiation of the web browser from which it originated. Rather, the stand-alone media player window 306 is generated using, for example, the native operating system and/or application programming interface of the host media presentation or computing device. FIG. 4 also depicts the always-on-top characteristic of the stand-alone media player window 306 (by default, it is initially displayed overlying the web browser window 300).

The default always-on-top display characteristics of the stand-alone media player window may be user-configurable or fixed. Settings, processor-executable instructions, and/or configuration parameters for the always-on-top display characteristics could be implemented with program code associated with the web browser application, program code associated with the operating system of the host media presentation or computing device, program code maintained by the provider or host of the media portal web page, or the like. For example, the media portal web page might allow a subscriber to log in and select the default always-on-top display characteristics for the stand-alone media player window. As another example, a user might be able to manipulate certain settings on the docked media player such that any stand-alone media player windows launched from the docked media player will have the default always-on-top feature. As yet another example, the web browser application may have a configuration or option setting that determines whether or not a launched media player window will have the always-on-top display characteristics.

In practice, the always-on-top feature of the stand-alone media player could be implemented using appropriate computer programming techniques, approaches, and/or code modifications. For example, the operating system of the host media presentation or computing device might support configurable settings and parameters that control or otherwise dictate the size, position, overlapping behavior, and other display characteristics of child, pop-up, or top-level windows. In this regard, the application programming interface of the host operating system could be programmed to support the default always-on-top feature.

Referring again to FIG. 6, the newly launched stand-alone media player window can automatically initiate presentation of media content (task 514), it could queue the media content and wait for the user to initiate a “play” command, it could idle with a blank screen until otherwise instructed, etc. For the embodiment illustrated in FIG. 6, the process 500 assumes that playback of the media content was initiated by the docked media player (see task 508). In such a scenario, it is generally desirable to continue the presentation of the media content in the stand-alone media player window in a seamless manner. Thus, task 514 may be executed to quickly activate the presentation of the media content (e.g., streaming media) in response to the detected activity, command, or instruction associated with the query task 510. This allows the user to continue viewing (or listening) to the same media content with the stand-alone media player in a seamless manner and without any significant interruptions, audible artifacts, or visual artifacts. Although not required in all implementations or in all situations, the process 500 may disable, stop, or end the presentation/playback of the media content by the docked media player (task 516). Disabling of the docked media player is generally desirable to avoid having multiple redundant and possibly unsynchronized instantiations of the same media content playing concurrently. For purposes of continuity and seamlessness, the process 500 could disable, end, or terminate the presentation of the media content (at the docked media player) at a specific runtime point of the content, and activate, begin, or start the presentation of the same media content (at the stand-alone media player) at or near the same runtime point. FIG. 4 depicts an exemplary situation where the docked media player 302 has been disabled and its screen blanked in response to the activation of the stand-alone media player window 306.

As explained previously, the stand-alone media player window can be maintained on top of other windows (e.g., application windows, operating system windows, pop-up messages, or the like) such that the user has a continuous view of the stand-alone media player window regardless of other activity, application focus, or manipulation of windows rendered on the display element of the host media presentation or computing device (task 518). In this regard, the host system can run at least one processor-executed application (other than the stand-alone media player) while still presenting streaming media in the stand-alone media player window. Moreover, the stand-alone media player window will remain on top of other windows (including any windows used for the other processor-executed applications) and will continue playback of the media content concurrently with manipulation of the other processor-executed applications. For example, as described above with reference to FIG. 5, the stand-alone media player window 402 remains fully visible whether or not any of the underlying application windows 404/406 have focus and whether or not any of the underlying application windows 404/406 are being manipulated or worked with.

The exemplary embodiment of the process 500 assumes that the default always-on-top mode of the stand-alone media player window can be changed to a different mode, e.g., an overlapping mode. Thus, if the process 500 detects or obtains an appropriate command to switch from the default always-on-top mode to an overlapping mode (query task 520), then the process 500 can initiate the mode change (task 522). This disables the always-on-top display characteristics of the stand-alone media player window, and, in certain embodiments, causes the stand-alone media player window to behave in a typical manner (such that other windows can partially or completely overlap and obscure it).

The process 500 has been described in the context of handing a given digital media file or a given streaming media event. In practice, some or all of the process 500 may be repeated as needed to support the presentation of any number of media files or events. Moreover, the default always-on-top display setting need not be changed or modified as described above. Furthermore, the media presentation or computing device may be suitably configured to switch back and forth between the default always-on-top mode, the overlapping mode, and possibly other display modes.

It should be appreciated that the stand-alone media player window could be implemented with other default and/or user-configurable display characteristics, features, and functionality (in addition to its default always-on-top feature). For example, it may be desirable to configure the stand-alone media player window such that by default it remains docked at a specified location or area of the display element (e.g., at the top left corner). As another example, it may be desirable to configure the stand-alone media player window such that by default it has a specified display size or resolution.

Furthermore, while at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method comprising:
directing the displaying of a web page comprising a media player on a display;
detecting activity associated with the media player; and
in response to the detected activity, rendering, on the display, an always-on-top media player for presentation of streaming media, the always-on-top media player being separate from the web page.

2. The method of claim 1, further comprising:
initially presenting the streaming media in the media player of the web page;
disabling presentation of the streaming media by the media player of the web page, in response to the detected activity associated with the web page; and
activating presentation of the streaming media by the always-on-top media player, in response to the detected activity associated with the web page.

3. The method of claim 2, wherein:
disabling presentation of the streaming media occurs at a runtime point of the streaming media; and
activating presentation of the streaming media occurs at the runtime point, such that presentation of the streaming media continues in the always-on-top media player in a seamless manner.

4. The method of claim 1, further comprising:
running at least one processor-executed application, other than the always-on-top media player; and
presenting the streaming media with the always-on-top media player concurrently with manipulation of the at least one processor-executed application.

5. The method of claim 1, further comprising providing, in the web page, a graphical control element corresponding to a launch media player command, wherein the always-on-top media player is rendered in response to interaction with the graphical control element.

6. The method of claim 1, wherein:
the directing step directs the displaying of the web page in a first window on the display;
the rendering step renders the always-on-top media player in a second window on the display; and
the first window is separate from the second window.

7. The method of claim 1, wherein:
the directing step directs the displaying of the web page in a browser window; and
the rendering step renders the always-on-top media player in a non-browser window.

8. A web browser application stored on tangible media of a computing device having a display associated therewith, the web browser application comprising processor-executable instructions that, when executed by the computing device, cause the computing device to perform a method comprising:
providing an embedded media player within a web page displayed on the display;
displaying a window for a media player on the display, the window being outside of, distinct from, and separate from the web page, the window by default having always-on-top display characteristics; and
presenting streaming media using the media player.

9. The web browser application of claim 8, the method further comprising detecting interaction with the web page, wherein displaying the window for the media player is initiated by the detected interaction.

10. The web browser application of claim 8, the method further comprising detecting interaction with the embedded media player, wherein displaying the window for the media player is initiated by the detected interaction.

11. The web browser application of claim 8, wherein the web browser application is stored on tangible media of a computing device selected from the group consisting of: a desktop computer; a portable computer; a handheld computer; a mobile telephone; a personal digital assistant; a video game console, a mobile video game device; a media server; a mobile media player device; a web-enabled audio/visual component; a medical device; a web-enabled household appliance; a set-top box; and a television component.

12. The web browser application of claim 8, the method further comprising:
beginning playback of the streaming media with the embedded media player; and
continuing playback of the streaming media, in a seamless manner, with the media player.

13. The web browser application of claim 12, the method further comprising disabling playback of the streaming media by the embedded media player at a designated runtime point of the streaming media, wherein continuing playback of the streaming media with the media player occurs at the designated runtime point.

14. The web browser application of claim 8, the method further comprising:
obtaining a command to switch from a default always-on-top mode of the media player to an overlapping mode of the media player; and
in response to the command, changing from the default always-on-top mode to the overlapping mode.

15. A method of presenting digital media content using a media presentation device configured to execute a web browser application, the method comprising:
rendering, on a display of the media presentation device, a docked media player and a graphical control element that represents an undock media player command;
detecting selection of the graphical control element;
in response to the detected selection of the graphical control element, launching a media player on the display, the media player being undocked from the docked media player, and the media player having default always-on-top display characteristics; and
presenting, with the media player, content associated with a digital media file.

16. The method of claim 15, further comprising presenting, with the docked media player, content associated with the digital media file.

17. The method of claim 15, further comprising disabling the docked media player in response to launching the media player.

18. The method of claim 15, further comprising executing at least one additional application with the media presentation device, wherein the media player presents the content concurrently with manipulation of the at least one additional application.

19. The method of claim 15, further comprising switching from the default always-on-top display characteristics of the media player to overlapping display characteristics of the media player.

20. The method of claim 15, further comprising:
beginning presentation of the content, using the docked media player; and
continuing presentation of the content in a seamless manner, using the media player.

21. The method of claim 15, wherein:
rendering the docked media player and the graphical control element is controlled by the web browser application; and
launching the media player is controlled by the web browser application.

22. The method of claim 15, wherein the media player is a stand-alone media player that is different than, and independent of, the docked media player.
